(19) United States
(12) Patent Application Publication
(10) Pub. No.: US 2004/0060050 A1
(43) Pub. Date: Mar. 25, 2004

(54) Method and controller for program control of a computer program having multitasking capability

(76) Inventor: Mathias Bieringer, Illingen (DE)

Correspondence Address: KENYON & KENYON, ONE BROADWAY, NEW YORK, NY, 10004, US

(21) Appl. No.: 10/608,796

(22) Filed: Jun. 27, 2003

(30) Foreign Application Priority Data
Jun. 27, 2002 (DE) 102 29 686.3

(51) Int. Cl. G06F 9/00

(52) U.S. Cl. 718/102

(57) ABSTRACT

A method and a controller for controlling the execution of a computer program having multitasking capability on a computing element especially on a microprocessor, of a controller for controlling and/or regulating a system which is able to take on various possible system states. In order to coordinate the execution of computer program in such a way that the input quantities required for the execution of a function of computer program are present with certainty at the beginning of the execution of the function, for each possible transition from one system state into another system state, transition conditions are defined and the execution of computer program is controlled in such a way that the system is only carried over from a first system state into a second system state when all the transition conditions specified for this transition are fulfilled.

### BACKGROUND INFORMATION

The present invention relates to a method for program control of a computer program having multitasking capability on a computing element, especially a microprocessor, of a controller for controlling and/or regulating a system. The system may assume various possible system states.

The present invention also relates to a control program for program control of a computer program having multitasking capability on a computing element, especially a microprocessor, of a controller for controlling and/or regulating a system which may take up various possible system states. The control program is capable of being run on the computing element.

Finally, the present invention also relates to a controller for the control and/or regulation of a system which may take up various possible system states. The controller includes a computing element, especially a microprocessor, on which a computer program having multitasking capability may be run, and means for coordinating the execution of the computer program.

Conventionally, a computer program is used, for example, for controlling and/or regulating a driving dynamics system (a so-called electronic stability program, ESP) of a motor vehicle. The driving dynamics system may assume various possible system states. Possible system states are, for instance, normal operation (ESP_normal), a first limited operation (backup_ABS), in which a vehicle regulator (FZR) of the ESP is not functioning and only one antilock brake system (ABS) is functioning, a second limited operation (backup_EBD), in which only one system for the distribution of braking force (electronic brake distribution (EBD) is able to function in order to prevent at least over-braking the wheels on the rear axle, and a faulty state (failsafe), in which all essential safety functions of the ESP, in particular FZR, ABS and EBD have failed. In order to avoid driving situations that are critical to safety, the driver of the motor vehicle is notified, for instance acoustically or optically by the use of warning lights, of the various system states, but at least of the states in which only a limited or a faulty functioning still exists. The computer program is executable on a computing element, which is particularly designed as a processor, of a controller for controlling and/or regulating the driving dynamics system.

Conventionally, the computer program for controlling and/or regulating the driving dynamics system is processed cyclically in a specified time pattern, i.e., only in a single time slice. The function references inside the computer program thus take place in a specified sequence, one after another. The sequence is specified so that the input variables of the functions are available before the execution of the latter. In the case of input variables which are computed from other functions, these other functions thus have to be carried out first, before that function can be carried out which needs the input variables computed in the other functions.

In addition, one may execute computer programs for controlling and/or regulating a system on an operating system having multitasking capability, and instead of processing the computer program in a single time pattern, one may process it in various time patterns. This means, however, that the functions of the computer program no longer have to be processed in a strictly fixed sequence, but that now other precautions have to be taken so as to ensure that the input variables of the functions are available before the execution of the latter.

Various priorities are allocated to the functions of the computer program. A higher priority is assigned to functions relevant to safety than to other functions. Higher priority functions are carried out in shorter time patterns, i.e., in time patterns which are repeated more frequently, whereas less safety-relevant functions are processed at a lower priority in longer time patterns which are repeated less often. It must particularly be ensured that the input variables of the functions are always present at the right point in time, i.e., a function which is processed, for example, in a 5 ms time pattern and requires input variables from a 40 ms time pattern, is permitted to be executed only after the 40 ms time pattern has been processed, and the required input variables have been computed.

An object of the present invention is to coordinate the execution of a computer program, having multitasking capability, in such a way that the input variables required for carrying out a function of the computer program are present with certainty at the beginning of carrying out the function.

In one example embodiment of the present invention, for each possible transition from one system state to another system state, transition conditions are defined, and the processing of the computer program is controlled in such a way that the system is carried over from a first system state to a second system state only when all the transition conditions defined for this transition have been satisfied.

### SUMMARY

The processing of a computer program capable of multitasking may be influenced in a controlled manner by the transition conditions defined according to the present invention. In particular, by a suitable definition of the transition conditions in the processing of the computer program that is capable of multitasking it may be ensured that, at the beginning of the execution of a function, all the input quantities required for the execution of this function, or at least suitable substitute quantities are present.

According to one advantageous refinement of the present invention, a transition condition includes at least one transition interrogation and at least one corresponding transition value as the specified response to the transition interrogation, a transition condition being considered as being satisfied when the specified transition value has been returned as the response to that or each transition interrogation. A transition interrogation may, for example, include an interrogation as to whether a certain input value is present which is needed for the processing of a function of the second system state (“Is input value xyz present?”). The respective transition value as the response to the interrogation is, for instance, yes or no, or 1 or 0 (“1”: input value is present). The system is carried over into the second system state only when the corresponding transition values are present for this transition interrogation and for all other transition interrogations which were defined for a desired system transition from a first to a second system state.

According to one preferred refinement of the present invention, transition values are filed in a transition table. In the transition table, the transition values may be filed subdivided according to system states. This means that, before making a change of the system into a certain system state, the system checks whether the responses to the transition interrogations correspond to the transition values filed in the transition table for this system state. The transition interrogations may be implemented, for instance, as logical IF-THEN interrogations. This has the advantage that the control of the program processing is able to be expanded in a simple way by the formulation of further transition interrogations and by filing further transition values in the transition table, and is able to be adapted to an expanded scope of functioning of the system.

According to another advantageous refinement of the present invention, the computer program is subdivided into a plurality of functionally linked functionalities; the possible system states of the system defined in that specifiable operating states are assigned to the functionalities for each system state; and the transition conditions are satisfied when at least the functionalities characterizing the second transition state have the operating states assigned for this system state. Thus, according to this refinement, the system states of the system are defined by the operating states of the functionalities. The system transits into another system state only when all the functionalities characterizing the system state have the required operating states. This is checked with the aid of the transition conditions, or rather, with the aid of the transition interrogations.

According to another preferred embodiment of the present invention, an operating state is defined by an operating state variable which is able to take on various operating state values; and the transition conditions are satisfied when the operating state variables of the functionalities characterizing the second system state have the operating state values assigned to them for this system state. This specific embodiment makes possible an especially simple and clear implementation of the present invention. Depending on how many operating states a functionality is able to take on, the operating state variable may include one bit (for two different operating states) or one byte (for 2\hat{ }8 different operating states).

Advantageously, the operating state variable may take on operating state values corresponding to the settings “full functionality”, “restricted functionality” and “no functionality”.

According to yet another preferred refinement of the present invention, one transition table is assigned to each functionality. Thus, in order to switch the system from a first to a second system state, first of all those functionalities of the computer program are ascertained by which the second system state is characterized. Then, the functionalities characterizing the second system state are checked to see whether they have the operating states assigned to them for the second system state. This is done in such a manner that, within the framework of transition interrogations, functionality by functionality is checked as to whether the operating state variable of the functionality has the operating state value assigned to it for the second system state and filed in the corresponding transition table. Thus, it is checked whether the transition conditions defined in the transition table for each function are satisfied.

According to yet another preferred specific embodiment of the present invention, a plurality of functionalities are combined into one component, and a transition table is assigned to each component. Thus, in one transition table, the transition values for several functionalities of one component are filed.

In addition, according to the present invention, two particularly advantageous uses are proposed of the method according to the present invention for controlling the execution of a computer having multitasking capability. On the one hand, using the method for controlling the execution of a computer program for controlling and/or regulating a system in a vehicle, especially a motor vehicle, is proposed. In particular, using the method for controlling the execution of a computer program for controlling and/or regulating a driving dynamics system in a motor vehicle, is proposed. On the other hand, using the method for controlling the execution of a computer program for controlling and/or regulating a system in a building is proposed. In particular, using the method for controlling the execution of a computer program for controlling and/or regulating an alarm system, a heating or air conditioning system and/or an access control system in a building is proposed.

Particularly significant is the implementation of the method according to the present invention in the form of a control program that is provided for the control and/or regulation of a system which is able to assume various possible system states. In this context, the control program is executable on a computing element, particularly on a microprocessor, of the controller and is suitable for carrying into effect the method according to the present invention. In this case, therefore, the present invention is implemented by way of the control program, so that the control program constitutes the present invention in the same way as the method for whose execution it is suitable. In this connection, it is preferred if the control program is stored on a storage element, especially on a-read-only memory, a random access memory or on a flash memory.

For each possible transition from one system state to another system state, means are provided for defining transition conditions, and means for controlling the processing of the computer program control the processing of the computer program is configured in such a way that the system is carried over from a first system state to a second system state only when all the transition conditions defined for this transition have been satisfied.

According to one advantageous further development of the present invention, the controller may have means for carrying out the method according to the present invention.

### BRIEF DESCRIPTION OF THE DRAWINGS

Further features, uses and advantages of the present invention come to light from the following description of exemplary embodiments of the present invention which are shown in the drawings. In this context, all of the described or represented features, alone or in any combination, form the subject matter of the present invention, regardless of their combination, formulation or representation in the specification and drawings.

FIG. 1 shows various system states of a system.

FIG. 2 shows a functionality of a computer program having multitasking capability for controlling and/or regulating a system.

FIG. 3 shows a flow diagram of a method for program control of a computer program having multitasking capability.

FIG. 4 shows a flow diagram of the method of the present invention, according to a preferred specific embodiment.

FIG. 5 shows a controller of the present invention according to one preferred specific embodiment.

### DESCRIPTION OF EXAMPLE EMBODIMENTS

The present invention relates to a computer program having multitasking capability for controlling and/or regulating a system. The computer program is executable on a computing element, particularly on a microprocessor, of a controller for controlling and/or regulating the system. The computer program having multitasking capability is processed in several different time patterns. The individual time patterns repeat cyclically, to be sure, but viewed on the whole, the computer program is not processed cyclically.

The computer program is subdivided into a plurality of tasks, to which various priorities are allocated. Higher priorities are assigned to tasks having safety-relevant objectives than to tasks which have no safety-relevant objectives. The higher priority tasks are carried out in shorter time patterns, i.e. they are processed more frequently per time unit than the lower priority tasks.

The subdivision of the computer program into a plurality of tasks relates to the software-technological implementation of the computer program. On the functional plane, the computer program is subdivided into a plurality of functionally coherent units, so-called functionalities. A functionality is able to include one or a plurality of tasks. In the case of a computer program for controlling and/or regulation of a driving dynamics system (electronic stability programs, ESP) in a motor vehicle, functionalities, such as an antilock brake system (ABS), which prevents locking of the wheels during braking, or an automatic vehicle controller (FZR), which undertakes well-directed braking interventions at the individual wheels, are provided in order to maintain the driving dynamics of the motor vehicle.

On account of the fact that, in a computer program having multitasking capability, the function requests do not simply follow one another, and thus it cannot be simply ensured by the sequence of the requests that the input variables of a functionality have already been ascertained by a previously executed functionality, in the case of computer programs having multitasking capability, other precautions have to be taken so as to ensure that the required input variables are always correctly present for the functionalities to be executed. Thus, a functionality which is called up in a 5 ms task and which needs input variables from a 40 ms task, at the first call is executed only if the 40 ms task had already been computed.

One aspect of the present invention is that transition conditions are assigned to each of the system states or rather to each (permissible) transition from a first system state to a second system state, and the execution of the computer program is controlled in such a way that the system is carried over into the second system state only when all the transition conditions assigned to the transition into the second system state have been satisfied. If, for example, the transition condition is that all input variables are available to a functionality characterizing the second system state, then, in the light of the method according to the present invention it may be ensured that the overall system is indeed only carried over from the first system state into the second system state when all the requisite input variables are present.

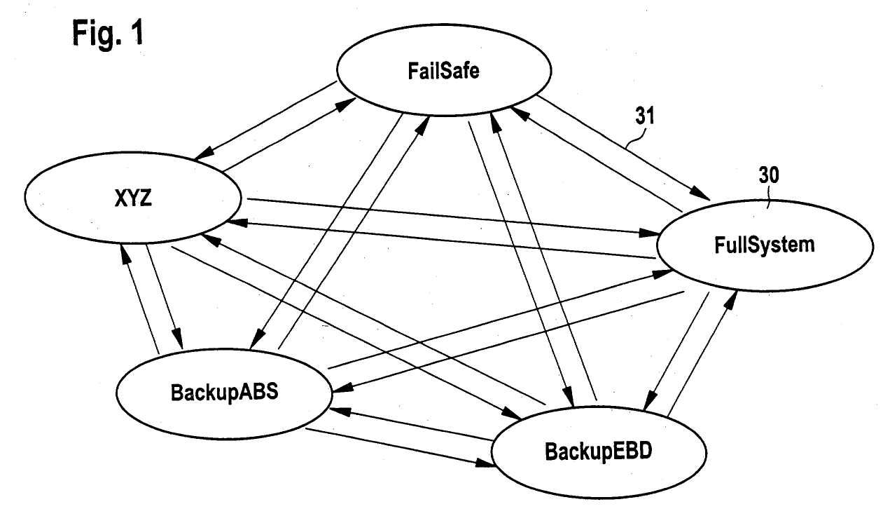

Various example system states 30 are shown in FIG. 1 by the example of a driving dynamics system (ESP). Among others, the following system states 30 are possible:

“full system”: normal operation, full operability of the driving dynamics system;

“backup_ABS”: antilock brake system (ABS) only, no vehicle controller (FZR) is active, limited operability;

“backup_ABS”: only electronic brake distribution (EBD) active, limited operability;

“failsafe”: FZR, ABS, EBD inactive, no operability of the system of any kind; and

“XYZ”: any other system state.

The transitions between the system states are marked with reference numeral 31.

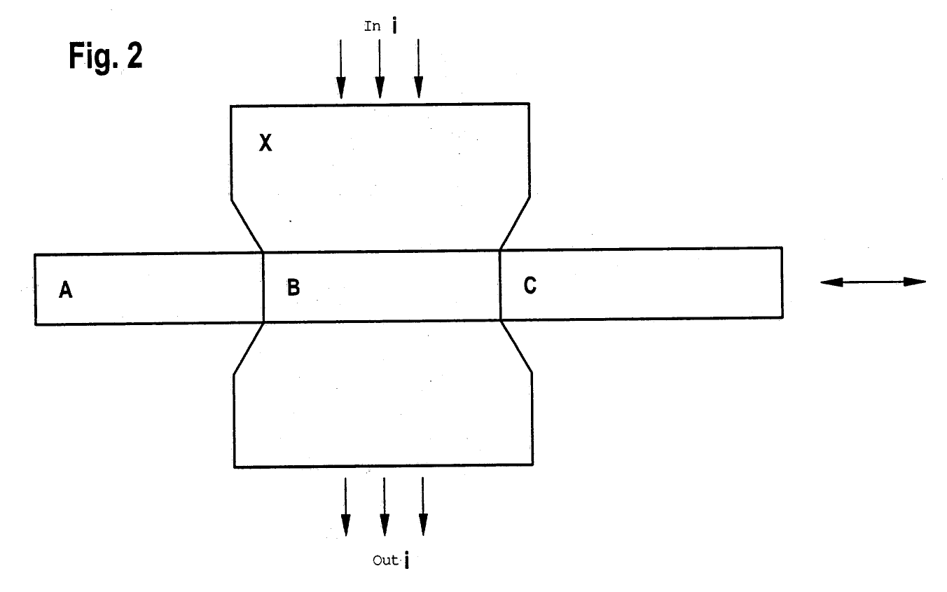

In FIG. 2, a functionality X is shown, which has the input variables in_i and the output variables out_i. Between input variables in_i and output variables out_i, a slider is provided that is able to be moved in the horizontal direction, which represents three different operating states A, B, C of functionality X. By sliding the slider, operating state A, B, C of functionality X may be changed.

The various system states 30 of the system are characterized by the fact that at least one of functionalities X of the system has a specifiable operating state A, B, C. The sum of operating states A, B, C of functionalities X thus yields corresponding system state 30 of the overall system. To each functionality X of the computer program, an operating state variable is assigned, which may assume various operating state variables which respectively correspond to a certain operating state A, B, C of functionality X.

Switching a functionality X into another operating state A, B, C may, for example, be required when not all input variables in_i, required to execute functionality X, are present. At first, one may try to delay the execution of this functionality X to the point that all required input variables in_i are present, i.e., until other functionalities X, in which the required input variables in_i were ascertained, have been executed. However, situations are possible in which delaying the execution of a functionality X, until all required input variables in_i are present, is not possible. In such a case, missing input variables in_i may also be modeled in the light of other variables, or may be computed by using an alternative algorithm. It is also possible, instead of the missing input variable in_i, to draw upon another variable which is already available, for executing functionality X. All these measures, however, which may be resorted to in case a required input variable in_i is not available, in the last analysis lead more or less to a limitation of the operability of the functionality, which is expressed by a change in operating state A, B, C.

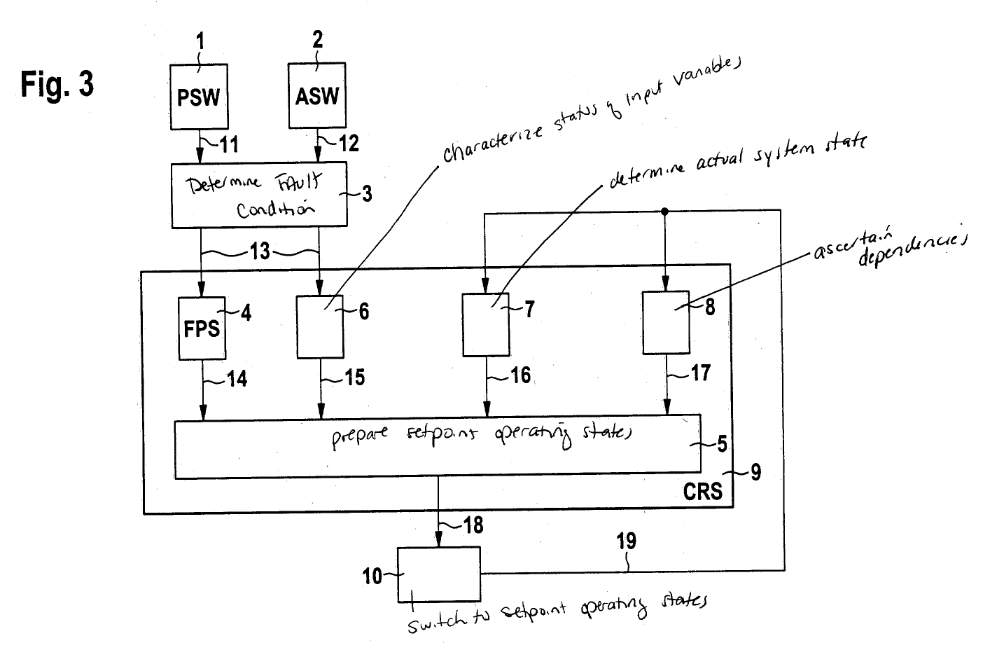

In FIG. 3, a method is shown for controlling the execution of a computer program having multitasking capability, for instance, in the light of a driving dynamics system in a motor vehicle. This method, and particularly the present invention may, however, be used for any system that is controlled and/or regulated by a computer program having multitasking capability. A further possibility for use, which is here addressed explicitly, is the use of the method according to the present invention for controlling the execution of a computer program for controlling and/or regulating an alarm system, a heating and air conditioning system and/or an access control system in a building, that is, the use of the method according to the present invention in the field of building management.

In a function block 1, the so-called platform software (PSW) is monitored. “Platform software” is the hardware-near part of the computer program for controlling and/or regulating the driving dynamics system. In a function block 2, user software (ASW) is monitored. “User software” is, in the case of a driving dynamics system, the ABS controller or the vehicle controller (FZR). Function blocks 1 and 2 are used to detect faults 11, 12 in the respective software components. A possible fault 11, 12, which could be detected in function blocks 1 and 2, would be, for example, a sensor fault which prevents a certain input variable in_i, which is required for the computation of a functionality X, from being available.

Faults 11, 12, detected in function blocks 1 and 2, are transmitted to a function block 3 which is implemented as a macro. In function block 3, in the light of faults 11, 12 ascertained in function blocks 1 and 2, a corresponding fault condition 13 of the system is determined. This fault condition 13 is transmitted by function block 3 to a further function block 4, which is denoted as failure processing system (FPS). While taking into consideration the ascertained fault conditions 13, in function block 4, an appropriate strategy for transition into the second system state, or more exactly, a strategy for targeted change of operating states A, B, C of the functionalities characterizing the second system state is determined. Strategy 14, determined in function block 4, for switching operating states A, B, C of functionalities X to transition into the second system state, is transmitted to a function block 5. Stated more exactly, according to determined strategy 14, one after another, various setpoint operating states are transmitted, from function block 4 to function block 5, of those functionalities which characterize the second system state. Determined strategy 14 in the present exemplary embodiment thus represents the second system state to a setpoint system state.

Fault conditions 13, determined in function block 3, are also transmitted to a function block 6, in which the status of input variables in_i of functionalities X are characterized by setting a so-called invalid bit. For each input variable in_i of functionalities X of the computer program, its own status signal in the form of the invalid bit is provided. Thus, when in function blocks 1 or 2 a sensor fault 11, 12 has been detected, those input variables in_i, which are impaired by sensor fault 11, 12, are characterized appropriately by the setting or deleting of the invalid bit. Status signal 15 is also transmitted to function block 5.

In a function block 7, actual system state 16 is ascertained and is also transmitted to function block 5. As an example of a driving dynamics system, actual system state 16 includes the state of the driving dynamics system per se, but also the driving state of the motor vehicle. In a function block 8, the dependencies 17 of operating states A, B, C and the functionalities X are ascertained among one another. The dependencies 17 ascertained are also transmitted to function block 5.

In function block 5, setpoint operating states 18 are prepared as a function of the variables 14, 15, 16, 17 obtained from function blocks 4, 6, 7, 8. In particular, it is checked in function block 5 whether the operating state variables of functionalities X have the operating state values required for the second system state, i.e., whether the functionalities characterizing the second system state are in the required operating states. Function blocks 4 through 8 are summarized in a superordinated function block 9, which is denoted as a controller release system (CRS).

In case it is determined in function block 5 that the operating state variables have the required operating state values, i.e., that the functionalities, which characterize the second system state, are in the required system state, function block 5 specifies one or a plurality of setpoint operating states 18 and transmits these to a function block 10. In function block 10 the user software (ASW) and a security software (SIS) as well as an offset preparation is contained. The ASW corresponds to the controller part of the software (e.g., to the ABS, ASR or engine torque controller). The corresponding functionalities in function block 10 are then switched to setpoint operating state 18. Actual operating state 19 is transmitted from function block 10 to function blocks 7 and 8. There they are drawn upon for ascertaining the actual system state in function block 7 and for ascertaining the dependencies of functionalities X among one another in function block 8.

During the transition from one operating state A, B, C to another, in principle, two different kinds of transition may be distinguished:

the transition from an operating state of a lower priority to an operating state of a higher priority as, for example, the transition from ABS_full system to ABS off. This transition takes place directly, so that further, possibly faulty controls are not able to occur.

the transition from an operating state of a higher priority to an operating state of a lower priority as, for example, from ABS_off to ABS_full system. In this case, the transition from the setpoint operating state to the actual operating state is determined by the functionality itself. In this context, the actual operating state must remain fully functionable until the setpoint operating state has been reached. During the switch-over phase from the actual operating state to the setpoint operating state, both operating states are computed in parallel. Thus, the functionality itself determines when the transition is to take place. It should be noted that, during the transition phase, acoustical or optical warning instructions must further be output. On the part of the FPS (failure processing system) in function block 4, warning instructions are no longer output, since by one reset, faults 11, 12 detected in function blocks 1 or 2 were already reset.

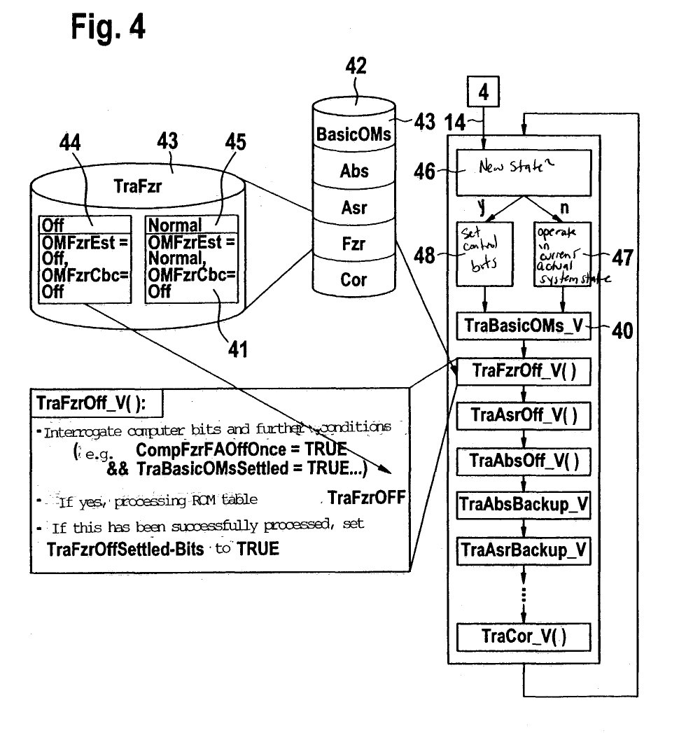

FIG. 4 shows a flowchart for the clarification of the method according to the present invention. In the method shown, the transition conditions include transition interrogations 40 and corresponding transition values 41 as specified responses to transition interrogations 40. A transition interrogation is seen as being fulfilled if the specified transition value 41 is returned as the response to this or any transition interrogation 40.

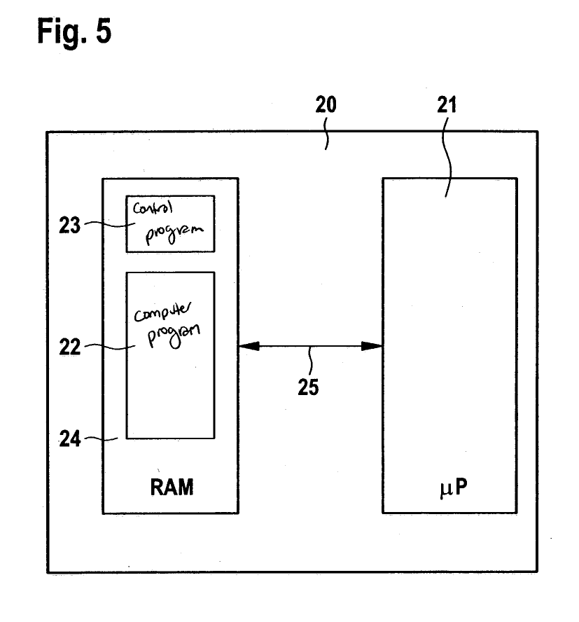

Computer program 22 (see FIG. 5) is subdivided into several coherent functionalities X. Possible system states (30) of the system are defined, in that specifiable operating states A, B, C are allocated to the functionalities (X) for each system state (30). The transition conditions are satisfied if at least the functionalities X, which characterize setpoint system state 14, have the assigned operating states A, B, C assigned to them for this system state 14.

Transition values 41 are filed in so-called transition tables 42. Transition tables 42 are designed as a knowledge data bank and are stored in a memory unit, particularly in a read-only memory (ROM) of a control unit 20 for controlling and/or regulating the system (see FIG. 5). It is possible to assign one transition table 42 to each functionality X. However, in the specific embodiment as in FIG. 4, several functionalities X are combined into one component 43, one transition table 42 being assigned to each component 43. In one component 43, functions are combined that make an outward appearance, for instance, fundamental functionalities X (basic operation modes; BasicOM's), ABS functionalities X, ASR functionalities, FZR functionalities X and functionalities X for coordinating braking torque requirements (COR).

The construction of transition tables 42 are explained in greater detail with the aid of a selected transition table 42 of an FZR component 43 (transition FZR, TraFZR). For two-component states 44 (off) and 45 (normal), corresponding operating states A, B, C of those functionalities are given which have been combined into FZR component 43. Operating state A, B, C is defined by an operating state variable OMFZREst, OMFZRCbc (CBC: Corner Brake Control for preventing over-braking of a wheel on the inside of a curve), which may assume various operating state variables (off, normal). The transition conditions are satisfied if the operating state variables OMFZREst, OMFZRCbc of functionalities X, characterizing system state 14, 16, have the operating state values (off, normal) which are assigned to them for this system state.

Transition interrogations 40 are contained in a program loop of computer program 22 (cf FIG. 5). The program loop is run through recursively, for example, every 20 ms. First the system checks in a function block 46 whether a new system state 14 has been requested. The appropriate signal 14 comes from FPS function block 4 (cf FIG. 3). If no new system state 14 of the system has been requested, the system continues to be operated in current actual system state 16 (function block 47). If a new system state 14 has been requested, control bits of transition interrogations 40 are set back in a function block 48. After that, transition interrogations 40 are processed, one after another. Transition interrogations 40 represent control functions of component states, whereby the system is illustrated.

One transition interrogation 40 (TraFZROff_V( )) is picked as an example and shown in detail. First, the state of control bits (such as CompFZRFAOffOnce=TRUE && TraBasicOMsSettled=TRUE . . . ) is interrogated and further conditions are interrogated. In the light of the queried control bits, the current state of the component or the individual functionalities may be ascertained. If the result of these interrogations is “YES”, this means that all the input values required to carry out the functionalities of component 43 are available, and corresponding input 44 (TraFZR_Off) in transition table 42 for component 43 (TraFZR) is processed. In this context, the system checks whether the functionalities of component 43 have the given operating states or are the functionalities being switched into the appropriate operating states. As soon as input 44 has been successfully processed in transition table 42, additional status bits are set to TRUE.

In FIG. 5, a controller according to the present invention is designated in its entirety by reference numeral 20. Controller 20 is used for controlling and/or regulating a system which can take on various possible system states, particularly of a driving dynamics system in a motor vehicle. Controller 20 includes a computing element 21 that is configured as a microprocessor. On computing element 21, a computer program 22, having multitasking capability, is executable, which is subdivided into several functionally coherent functionalities. Computer program 22 is used to control or regulate the system according to the present invention when it runs on computing element 21. Furthermore, in controller 20, means 23 are provided for the coordination of the execution of computer program 22. Means 23 are designed as a control program which is also executable on computing element 21. Computer program 22 and control program 23 are stored on a storage element 24, which, for example, is designed as a flash memory. In order to process computer program 22 and control program 23, these are transmitted to computing element 21 either in total or section by section via a data connection 25. In the same manner, results of computations that were carried out in computing element 21, or other data, may be transmitted to storage element 24 in the opposite direction via data connection 25, and stored there. Control program 23 is used for carrying out the method according to the present invention when it is carried out on computing element 21.

What is claimed is:

1. A method for controlling an execution of a computer program having multitasking capability on a computing element of a controller at least one of controlling and regulating a system that is able to assume various possible system states, comprising:
defining transition conditions for each possible transition of one of the system states into another of the system states; and
controlling the execution of the computer program in such a way that the system is transitioned from a first system state into a second system state only when all of the transition conditions defined for the transition have been fulfilled.

2. The method according to claim 1, wherein the computing element is a microprocessor.

3. The method as recited in claim 1, wherein each one of the transition conditions includes at least one transition interrogation and at least one corresponding transition value as a response given to the transition interrogation, the one of the transition conditions being regarded as having been fulfilled when the transition value is returned as the response to the transition interrogation.

4. The method as recited in claim 3, further comprising:
filing the transition values in a transition table.

5. The method as recited in claim 1, wherein the computer program is subdivided into a plurality of functionally linked functionalities, and wherein the method further comprises:
allocating specifiable operating states to the functionalities for each of the system states, the transition conditions being satisfied if at least the functionalities which characterize the second system state have the operating states allocated to them for the second system state.

6. The method as recited in claim 5, wherein each of the operating states is defined by an operating state variable which is able to take on various operating state values, and wherein the transition conditions are satisfied if at least the operating state variables of the functionalities which characterize the second system state have the operating state values defined for them for the second system state.

7. The method as recited in claim 5, wherein the operating state variable is able to take on operating state values corresponding to the settings “full functionality”, “limited functionality” and “no functionality”.

8. The method as recited in claim 5, further comprising:
assigning a transition table to each of the functionalities.

9. The method as recited in claim 5, wherein a plurality of functionalities are combined into a component and a transition table is assigned to the component.

10. The method as recited in claim 1, wherein the system is a system in a vehicle.

11. The method according to claim 10, wherein the vehicle is a motor vehicle.

12. The method as recited in claim 11, wherein the system is a driving dynamics system in the motor vehicle.

13. The method as recited in claim 1, wherein the system is a system in a building.

14. The method as recited in claim 13, wherein the system is at least one of an alarm system, a heating and air conditioning system, and an access control system in the building.

15. A storage element storing a control program for controlling execution of a computer program having multitasking capability on a computing element of a controller for at least one of controlling and regulating a system that can assume various possible system states, the control program being executable on the computing element, wherein the control program causes the computing element to perform a method comprising:
defining transition conditions for each possible transition of one of the system states into another of the system states; and
controlling the execution of the computer program in such a way that the system is transitioned from a first system state into a second system state only when all of the transition conditions defined for the transition have been fulfilled.

16. The storage element as recited in claim 15, wherein the control program is stored on one of a storage read-only memory, a random access memory, or a flash memory.

17. A controller for at least one of controlling and regulating a system which is able to assume various possible system states, comprising:
a computing element on which a computer program having multitasking capability may be run;
an arrangement for controlling execution of the computer program; and
an arrangement for defining transition conditions for every possible transition from one system state into another system state;
wherein the arrangement for controlling the execution of the computer program controls the execution of the computer program in such a way that the system changes from a first system state into a second system state only when all of the transition conditions defined for the transition are fulfilled.

18. The controller according to claim 17, wherein the computing element is a microprocessor.

19. The controller as recited in claim 17, wherein each one of the transition conditions includes at least one transition interrogation and at least one corresponding transition value as a response given to the transition interrogation, the one of the transition conditions being regarded as having been fulfilled when the transition value is returned as the response to the transition interrogation.
